(19) United States
(12) Patent Application Publication
(10) Pub. No.: US 2009/0161015 A1
(43) Pub. Date: Jun. 25, 2009

(54) Display device, video signal correction device, and video signal correction method

(75) Inventor: Yasunobu Kato, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/314,043

(22) Filed: Dec. 3, 2008

(30) Foreign Application Priority Data
Dec. 20, 2007 (JP) 2007-328181

(51) Int. Cl. H04N 5/14; H04N 5/66

(52) U.S. Cl. 348/571; 348/739; 348/E05.133; 348/E05.062

(57) ABSTRACT

Disclosed herein is a display device including: a display unit configured to carry out video displaying on a display panel based on a supplied video signal; and a video signal correcting unit configured to output a corrected video signal value obtained through arithmetic operation including division operation in response to an input video signal value, as correction processing suited to a characteristic of the display panel for a video signal to be supplied to the display unit, wherein the video signal correcting unit includes a memory table block having a plurality of reference tables, and a correction operation block that calculates a corrected video signal value through arithmetic operation including all or a part of addition, subtraction, and multiplication by using an input video signal value and the operation result values read out from reference tables dependent upon the input video signal value in the memory table block.

### CROSS REFERENCES TO RELATED APPLICATIONS

The present invention contains subject matter related to Japanese Patent Application JP 2007-328181 filed in the Japan Patent Office on Dec. 20, 2007, the entire contents of which being incorporated herein by reference.

### BACKGROUND OF THE INVENTION

1. Field of the Invention

The present invention relates to a display device, a video signal correction device, and a video signal correction method, and relates to a technique for enhancing the uniformity of displaying by correcting unevenness of the luminance and the chromaticity as characteristics of a display panel.

2. Description of the Related Art

As disclosed in e.g. Japanese Patent Laid-Open No. 2005-195832, an unevenness correction device called a 3D-γ system is put into practical use in order to correct luminance unevenness and chromaticity unevenness of a display device (or display panel, simply) to thereby improve the uniformity thereof. In the 3D-γ system, the corrected value is decided depending on the coordinates of the X direction, the Y direction, and the grayscale direction (Z direction) of the panel.

This unevenness correction device is incorporated in a television device or another video display device as a circuit unit that executes correction processing for a video signal to be supplied to a display panel unit.

FIG. 8 shows an example of the signal correction by the unevenness correction circuit. This example is a 2D map diagram of a luminance-corrected image that should be output when a video signal for a uniform-luminance image is input to a display panel.

For example, the range of the grayscale value as the luminance value in this example is from 0 to 1023, i.e. the number of grayscale values is 1024. If a luminance signal with a grayscale value of “512” is supplied to the entire screen, i.e. all of the pixels of the screen, the entire screen should display a uniform image corresponding to the grayscale value of “512.” However, in practice, parts darker and brighter than the part corresponding to the grayscale value of 512 arise on the screen due to luminance unevenness and so on of the display panel itself. This corresponds to the state in which the uniformity of the screen is low. To eliminate this state, the video signal values to be supplied to the respective pixels are corrected suitably to the characteristic of the luminance unevenness.

Specifically, a signal for a part that is to have luminance lower than the intended luminance on the non-adjusted panel is converted into a signal corresponding to higher luminance, and a signal for a part that is to have luminance higher than the intended luminance on the non-adjusted panel is converted into a signal corresponding to lower luminance. The converted signals are supplied to the display panel as corrected video signals, which allows outputting of the desired uniform-luminance image.

For example, to the pixel of a part that has luminance lower than the luminance corresponding to a grayscale value of “512” although the grayscale value of “512” is supplied to this part, the signal value resulting from correction to the grayscale value larger than “512,” dependent upon the luminance difference, is supplied.

Furthermore, to the pixel of a part that has luminance higher than the luminance corresponding to the grayscale value of “512” although the grayscale value of “512” is supplied to this part, the signal value resulting from correction to the grayscale value smaller than “512,” dependent upon the luminance difference, is supplied.

FIG. 8 shows grayscale values as such corrected values on the XY plane equivalent to the screen plane, and the corrected grayscale values are represented by the shading of the respective pixels.

This correction prevents the lowering of the uniformity of the display panel due to the luminance unevenness characteristic of the display panel, and thus allows higher-quality image displaying.

In the unevenness correction circuit as the 3D-γ system, such 2D maps are prepared for uniform images corresponding to various luminance values.

FIG. 9 shows the input/output function of the panel luminance correction, graphed with attention paid on the Z direction (grayscale direction) of the 3D-γ system.

If the panel is completely uniform originally, the input/output function thereof is represented by the straight-line graph, which corresponds to the state in which the grayscale value of the input signal is directly output without correction. However, the graph of FIG. 9 shows that the actual input/output function involves variations for correcting the uniformity on a pixel-by-pixel basis.

For example, in the case of a grayscale value Ain on the input side (on the abscissa), the corrected grayscale values on the output side (on the ordinate) are in the range from Aout1 to Aout2. This is equivalent to the following circumstances. Specifically, in displaying of a uniform image through supply of a video signal with the grayscale value Ain to all of the pixels, the grayscale value needs to be corrected for each pixel in order to actually display the uniform image. As a result, the corrected values for the respective pixels are in the range from Aout1 to Aout2.

Such a corrected-value range differs from grayscale to grayscale. Due to this variation from grayscale to grayscale, the above-described 2D map needs to be prepared for each grayscale value.

As shown in FIG. 10, the unevenness correction circuit is composed of a look-up table unit 100 and a correction operation circuit 101.

In the look-up table unit 100, a look-up table as the above-described 2D map is stored for each grayscale value. In each look-up table, the grayscale value as the corrected value (or coefficient for obtaining the corrected grayscale value) corresponding to the input grayscale value is stored for each pixel.

The correction operation circuit reads out, from the look-up table unit 100, the numerical values necessary for arithmetic operation for the input original video signal values every time the video signal values are input. The correction operation circuit calculates the video signal values that allow correction of luminance unevenness and chromaticity unevenness of the panel by using these numerical values, and outputs the calculated video signal values.

If the unevenness correction data are held for all of the X direction, the Y direction, and the Z direction, the data amount is significant impractically. Therefore, a method is frequently employed in which corrected values are stored in 2D maps for representative Z coordinates (grayscale values) and corrected values for another Z coordinate are estimated from the representative corrected values.

For example, the example of FIG. 9 is based on an assumption that 1024 grayscale values (along the Z direction) from “0” to “1023” are available. However, it is impractical that the 3D-γ system is constructed by holding 1024 2D maps (look-up tables).

Therefore, of the values from “0” to “1023,” n representative input values, such as “0,” “64,” “128,” . . . , “1023,” obtained through sampling of some grayscale values along the Z direction are set, and n look-up tables corresponding to these n representative input values are held.

If the input video signal value is a grayscale value that is not sampled, interpolation calculation is carried out by using corrected values stored in the look-up tables of two sampled grayscale values that are larger and smaller, respectively, than this input video signal value and closest to this input video signal value. The corrected values are obtained through e.g. linear interpolation calculation. This linear interpolation calculation will be described below with reference to FIG. 11.

FIG. 11B shows n look-up tables TB1, TB2, . . . , TB(n) stored in the look-up table unit 100.

In FIG. 11A, the input grayscale value is plotted on the abscissa, and the output grayscale value resulting from correction is plotted on the ordinate.

The following description is based on an assumption that the grayscale value of the input video signal is Zin and the look-up table corresponding to this input grayscale value Zin is not prepared.

The input grayscale value Zin is between the input grayscale values of the look-up tables TB(m) and TB(m−1) in FIG. 11B.

Specifically, if the input grayscale value corresponding to the look-up table TB(m) is Zin2U and the input grayscale value corresponding to the look-up table TB(m−1) is Zin2L, the input grayscale value Zin exists between the grayscale values Zin2L and Zin2U, which are sampled as Z coordinate values, as shown in FIG. 11A.

The corrected values read out from the look-up tables TB(m) and TB(m−1) are Zout2U and Zout2L, respectively. The correction operation circuit 101 executes the arithmetic operation represented by the following equation in order to obtain an output grayscale value Zout resulting from the correction.

Zout={Zout2U×(Zin−Zin2L)+Zout2L×(Zin2U−Zin)}/(Zin2U−Zin2L) (Equation 1)

The correction operation circuit 101 for executing this arithmetic operation has the circuit configuration shown in FIG. 12, specifically.

A subtractor 110 subtracts the input grayscale value Zin2L of the look-up table TB(m−1) (representative input value as a Z coordinate value) from the input grayscale value Zin (Zin−Zin2L).

A subtractor 111 subtracts the input grayscale value Zin from the input grayscale value Zin2U of the look-up table TB(m) (representative input value as a Z coordinate value) (Zin2U−Zin).

A multiplier 112 multiplies the output (Zin−Zin2L) from the subtractor 110 by the corrected value (output grayscale value) Zout2U of the look-up table TB(m) (Zout2U×(Zin−Zin2L)).

A multiplier 113 multiplies the output (Zin2U−Zin) from the subtractor 111 by the corrected value (output grayscale value) Zout2L of the look-up table TB(m−1) (Zout2L×(Zin2U−Zin)).

An adder 114 adds the outputs of the multipliers 112 and 113 to each other ((Zout2U×(Zin−Zin2L)+(Zout2L×(Zin2U−Zin)).

A subtractor 115 subtracts the input grayscale value (Z coordinate value) Zin2L of the look-up table TB(m−1) from the input grayscale value (Z coordinate value) Zin2U of the look-up table TB(m) (Zin2U−Zin2L).

A divider 116 divides the output of the adder 114 by the output of the subtractor 115. The output of the divider 116 is equivalent to the operation result represented by the equation shown above.

### SUMMARY OF THE INVENTION

Although the configuration of FIG. 12 includes the divider 116, it is generally difficult to implement the divider by hardware, and the provision of the divider involves problems of increase in the system cost and difficulty in speed enhancement.

As a method to avoid this problem, it would be possible to employ a method in which a power of two is employed as the integer (Zin2U−Zin2L) of the denominator of (Equation 1) and the divider is replaced by a shift operation unit. This is because the shift operation unit can be formed with a simpler circuit compared with the divider.

However, in this case, the interval of the sampling of the representative input values along the Z axis (grayscale value) direction needs to be set to a power of two, and therefore the flexibility of the setting of the representative input values is limited.

Flexible setting of the representative input values is desired, such as unequal-interval sampling in which small sampling intervals are set for a low-luminance range and a high-luminance range in the sampling along the Z direction. However, it is impossible to realize such setting with use of only the shift operation unit.

There is a need for the present invention to, for correcting luminance unevenness and chromaticity unevenness of a display panel to thereby improve the uniformity thereof, allow calculation of a corrected value through only addition, subtraction, and multiplication without executing division operation as arithmetic operation by hardware, to thereby solve the above-described problem.

According to an embodiment of the present invention, there is provided a display device including a display unit configured to carry out video displaying on a display panel based on a supplied video signal, and a video signal corrector configured to output a corrected video signal value obtained through arithmetic operation including division operation in response to an input video signal value, as correction processing suited to a characteristic of the display panel for a video signal to be supplied to the display unit. The video signal corrector includes a memory table unit having a plurality of reference tables that each correspond to a respective one of a plurality of representative input values as video signal values and each store operation result values of the division operation in advance. The video signal corrector further includes a correction operation unit that calculates a corrected video signal value through arithmetic operation including all or a part of addition, subtraction, and multiplication by using an input video signal value and the operation result values read out from reference tables dependent upon the input video signal value in the memory table unit.

According to another embodiment of the present invention, there is provided a video signal correction device that outputs a corrected video signal value obtained through arithmetic operation including division operation in response to an input video signal value, as correction processing suited to a characteristic of a display panel for a video signal to be supplied to a display unit that carries out video displaying on the display panel based on a supplied video signal. The video signal correction device includes a memory table unit configured to have a plurality of reference tables that each correspond to a respective one of a plurality of representative input values as video signal values and each store operation result values of the division operation in advance. The video signal correction device further includes a correction operation unit configured to calculate a corrected video signal value through addition-and-subtraction operation and/or multiplication operation with use of an input video signal value and the operation result values read out from reference tables dependent upon the input video signal value in the memory table unit.

According to yet another embodiment of the present invention, there is provided a video signal correction method of outputting a corrected video signal value obtained through arithmetic operation including division operation in response to an input video signal value, as correction processing suited to a characteristic of a display panel for a video signal to be supplied to a display unit that carries out video displaying on the display panel based on a supplied video signal. The video signal correction method includes the step of referring to a memory table unit having a plurality of reference tables that each correspond to a respective one of a plurality of representative input values as video signal values and each store operation result values of the division operation in advance, to thereby read out the operation result values from reference tables dependent upon an input video signal value. The video signal correction method further includes the step of calculating a corrected video signal value through arithmetic operation including all or a part of addition, subtraction, and multiplication by using the input video signal value and the operation result values.

That is, the embodiments of the present invention relate to a video signal correction device configuration as a 3D-γ system that is aimed at correcting luminance unevenness and chromaticity unevenness of a display panel to thereby improve the uniformity thereof, and in which the corrected value is decided depending on the coordinates of the X direction, the Y direction, and the grayscale direction (Z direction) of the display panel. The video signal corrector (video signal correction device) includes the memory table unit having the reference tables (look-up tables) and the correction operation unit formed of any of various kinds of operation circuits. In the reference tables, correction data in the form of being obtained through division calculation in advance are stored. This feature allows the correction operation unit to execute corrected-value calculation including interpolation through arithmetic operation within the range of addition, subtraction, and multiplication, without executing division operation.

According to the embodiments of the present invention, it is possible to form a configuration that does not include a divider as hardware as the circuit configuration of the correction operation unit for linear interpolation operation about the grayscale direction of the 3D-γ.

This can eliminate the problems of increase in the system cost and difficulty in speed enhancement.

Moreover, using no divider eliminates the limit that the interval of the sampling of the representative input values along the Z axis (grayscale value) direction needs to be set to a power of two in order to simplify the divider.

Specifically, any interval other than powers of two can be freely selected in the setting of the representative input values and substantially-equal intervals and unequal intervals can also be set. Furthermore, the intervals can be changed even after the circuit configuration as the correction operation unit is fixed. In this manner, the flexibility of the setting of the representative input values can be enhanced.

### BRIEF DESCRIPTION OF THE DRAWINGS

FIG. 1 is a block diagram of a display device according to an embodiment of the present invention;

FIG. 2 is a block diagram of an unevenness corrector of the embodiment;

FIG. 3 is a circuit diagram of a correction operation circuit in the unevenness corrector of the embodiment;

FIG. 4 is an explanatory diagram of look-up tables of the embodiment;

FIGS. 5A and 5B are explanatory diagrams of the representative input values of the look-up tables of the embodiment;

FIG. 6 is an explanatory diagram of readout of operation result values from the look-up tables of the embodiment;

FIGS. 7A and 7B are explanatory diagrams of setting of the representative input values with equal intervals and unequal intervals, respectively, of the embodiment;

FIG. 8 is an explanatory diagram of a 2D map for unevenness correction;

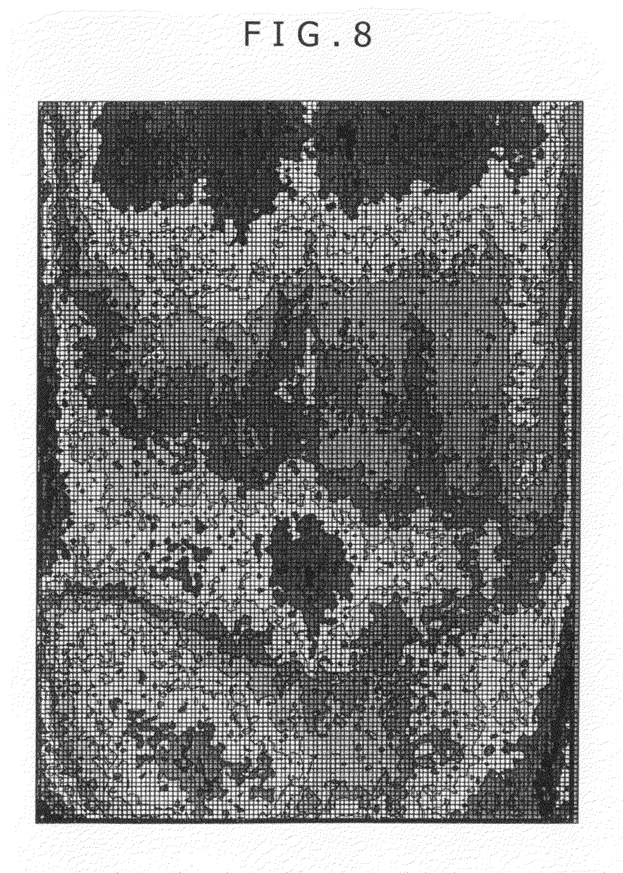

FIG. 9 is an explanatory diagram of the relationship between an input value and a corrected value in a correction table;

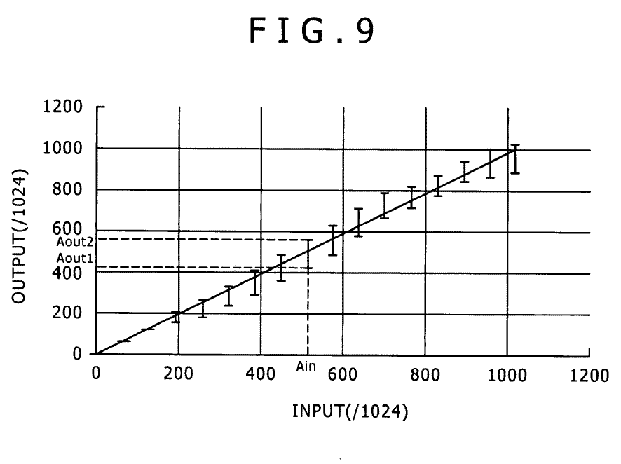

FIG. 10 is an explanatory diagram of the configuration of a correction circuit;

FIGS. 11A and 11B are explanatory diagrams of linear interpolation in correction operation, and

FIG. 12 is a circuit diagram of a related-art correction operation circuit.

### DETAILED DESCRIPTION OF THE PREFERRED EMBODIMENT

An embodiment of the present invention will be described below.

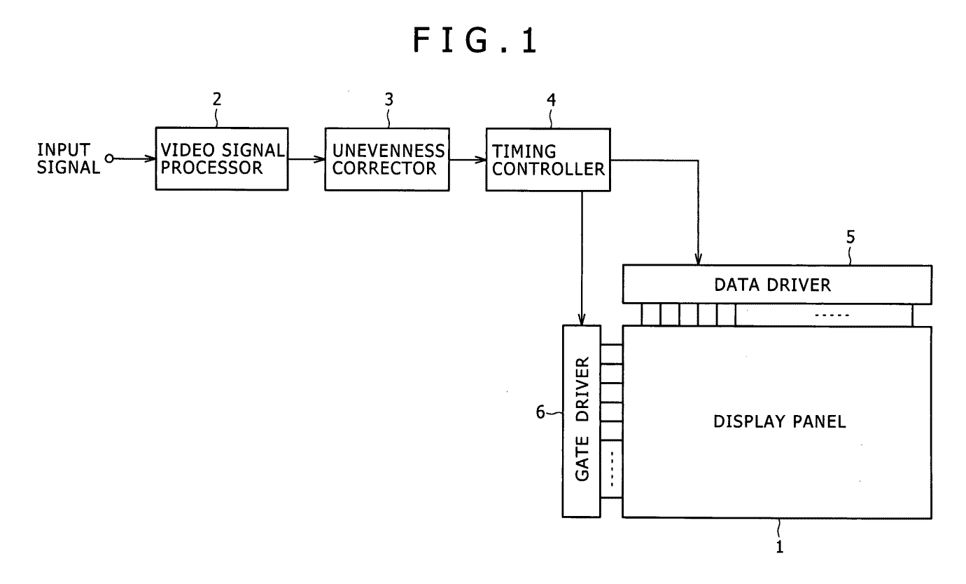

FIG. 1 is a block diagram of the configuration of major part of a display device according to the embodiment. This display device can be used as a television receiver, a monitor display device, a display device part in various kinds of information apparatus, and so on.

A video signal processor 2 executes video signal processing in response to an input signal. If the display device is a television receiver for example, the input signal is a received broadcasting signal, and the video signal processor 2 executes processing of extracting a video signal from the received signal. If the display device is video reproduction apparatus, the input signal is a signal read out from a recording medium, and the video signal processor 2 executes video signal reproduction processing. If the display device is network apparatus, the video signal processor 2 executes processing of decoding communication data and so on for the input signal obtained through network communication.

That is, in FIG. 1, the video signal processor 2 is shown as a unit that extracts a video signal input via any transmission path and executes the necessary processing so as to output the resulting signal as e.g. RGB video signals.

The video signals as an R signal, a G signal, and a B signal output from the video signal processor 2 are supplied to an unevenness corrector 3. The unevenness corrector 3 outputs corrected video signal values obtained by arithmetic operation including division operation for the respective input video signal values of R, G, and B, as correction processing suited to the unevenness characteristics (luminance unevenness, chromaticity unevenness) of a display panel 1. The details thereof will be described later.

A timing controller 4 supplies the RGB video signals corrected by the unevenness corrector 3 to a data driver 5 at predetermined timings, and supplies scan timings to a predetermined gate driver 6.

The display panel 1 is e.g. an organic electroluminescence (EL) display panel or a liquid crystal panel. In the display panel 1, pixel circuits are arranged in a matrix along the horizontal direction (X direction) and the vertical direction (Y direction). The pixel circuits are driven on a line-by-line basis based on video signal values supplied from the data driver 5 at each line scan timing dependent upon the gate driver 6, and thereby video displaying is carried out.

For example, in such a display device, a feature of the present embodiment exists in the unevenness corrector 3.

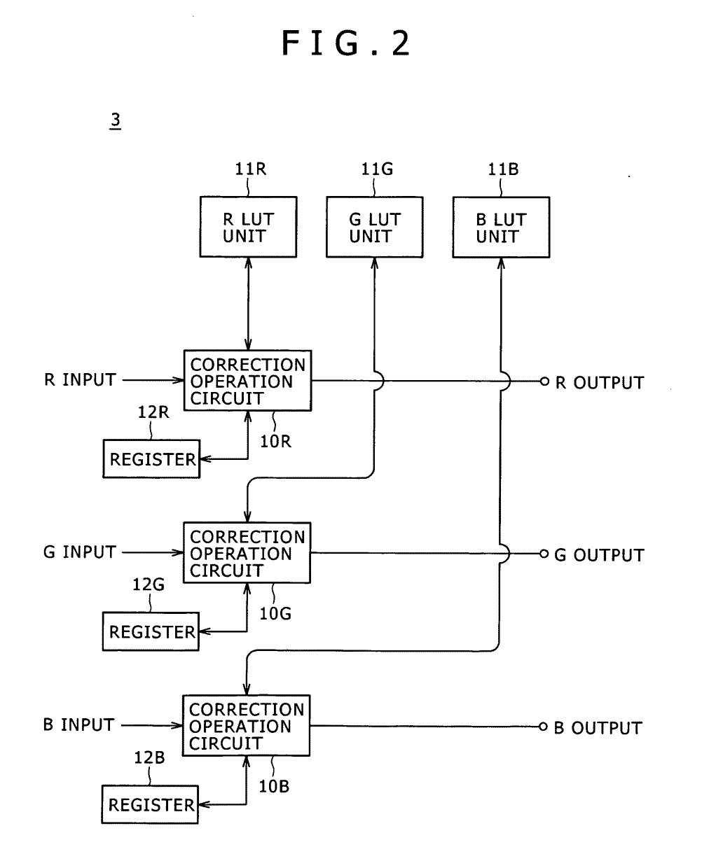

FIG. 2 shows a configuration example of the unevenness corrector 3.

The unevenness corrector 3 has a circuit configuration for correction of unevenness of video signal values corresponding to each of the R signal, the G signal, and the B signal. As the configuration for the R signal, the unevenness corrector 3 includes an R look-up table (LUT) unit 11R, a correction operation circuit 10R, and a register 12R. Furthermore, the unevenness corrector 3 includes a G LUT unit 11G, a correction operation circuit 10G, and a register 12G as the configuration for the G signal, and includes a B LUT unit 11B, a correction operation circuit 10B, and a register 12B as the configuration for the B signal.

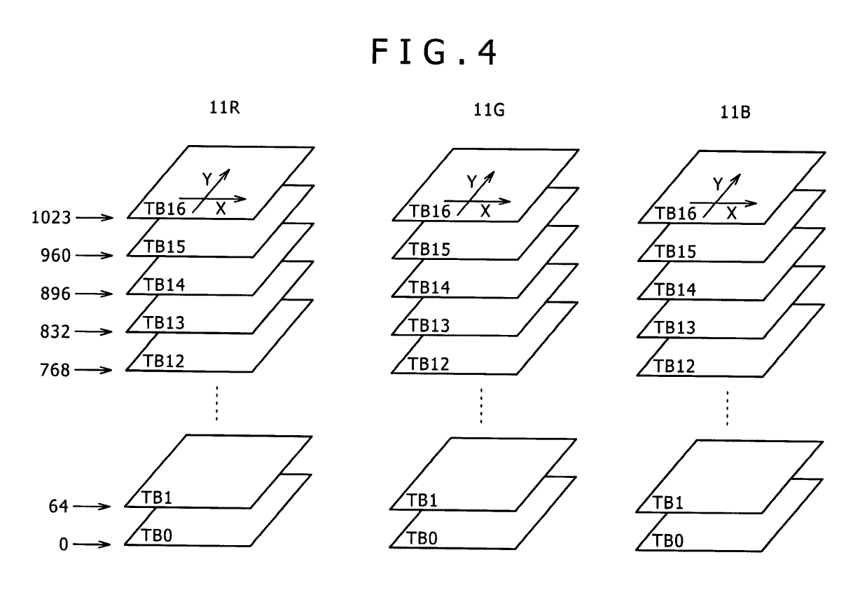

The R LUT unit 11R, the G LUT unit 11G, and the B LUT unit 11B are prepared by using e.g. a dynamic random access memory (D-RAM) or a synchronous D-RAM (SD-RAM) as one kind of D-RAM. In the present example, each of the R LUT unit 11R, the G LUT unit 11G, and the B LUT unit 11B includes e.g. 17 look-up tables TB0, TB1, . . . , TB16 as shown in FIG. 4.

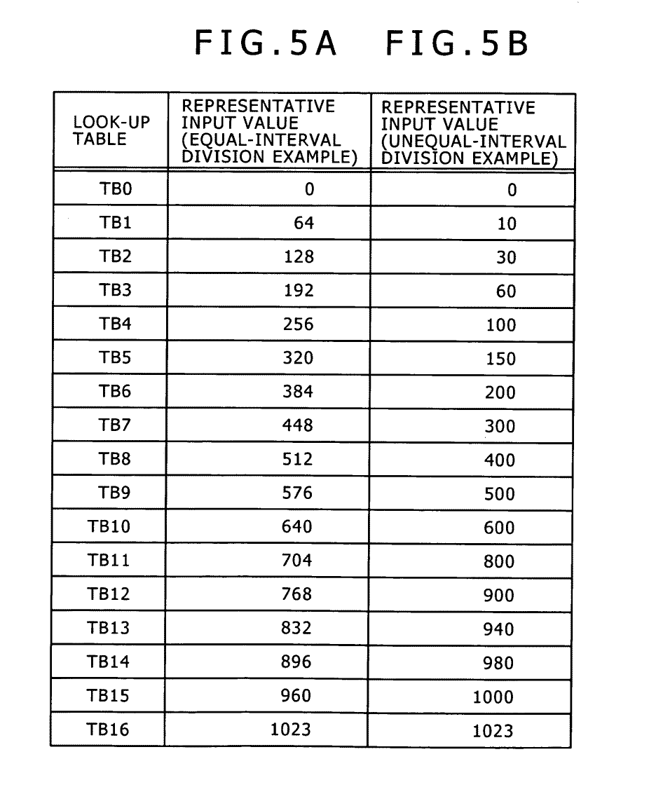

FIG. 5A shows an example in which grayscale values “0” to “1023” are divided with substantially-equal intervals for setting representative input values. The look-up tables TB0 to TB16 of FIG. 4 correspond to these representative input values set through the equal-interval division for example.

In this case, the look-up table TB0 is a table memory corresponding to the grayscale value “0,” the look-up table TB1 is a table memory corresponding to the grayscale value “64,” . . . , the look-up table TB16 is a table memory corresponding to the grayscale value “1023.”

In each of the look-up tables TB0 to TB16, values for correction operation corresponding to the respective pixels along the X and Y directions of the display panel are stored corresponding to the representative input value.

In particular, in the present example, the unevenness corrector 3 outputs corrected values through arithmetic operation processing including division operation, and the values for correction operation, stored in the respective look-up tables TB0 to TB16, are the operation result values of this division operation.

In the registers 12R, 12G, and 12B shown in FIG. 2, the representative input values of the respective look-up tables TB0 to TB16 in the R LUT unit 11R, the G LUT unit 11G, and the B LUT unit 11B, respectively, are stored. For example, the values “0,” “64,” “128,” . . . , “1023” shown in FIG. 5A are stored as the representative input values of the respective look-up tables TB0 to TB16.

If the R LUT unit 11R, the G LUT unit 11G, and the B LUT unit 11B are identical to each other in the number of look-up tables TB and the representative input values as shown in FIG. 4, the plural registers as the registers 12R, 12G, and 12B do not necessarily need to be provided for the respective channels of R, G, and B, but one register in common to the R, G, and B channels may be used. However, if the number of look-up tables TB and the representative input values could be varied on a color-by-color basis, it is appropriate to provide the plural registers as the registers 12R, 12G, and 12B for the respective channels of R, G, and B.

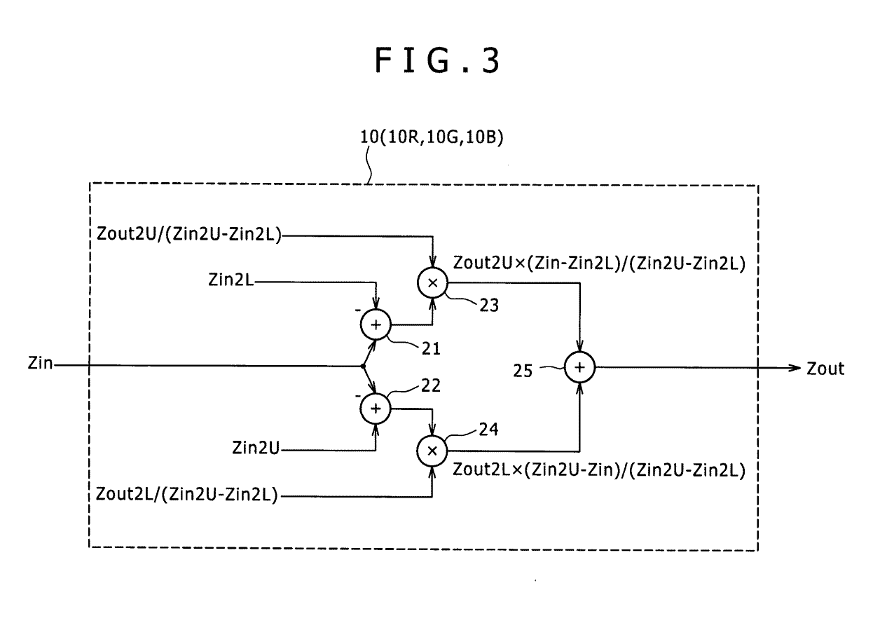

As shown in FIG. 3, each of the correction operation circuits 10R, 10G, and 10B includes subtractors 21 and 22, multipliers 23 and 24, and an adder 25.

When a video signal value Zin as the R signal is input to the correction operation circuit 10R, the correction operation circuit 10R reads out, from the R LUT unit 11R, the values for correction operation (operation result values of division operation) in two look-up tables dependent upon the video signal value Zin. Furthermore, the correction operation circuit 10R reads out the representative input values of these two look-up tables from the register 12R. By using these values, the correction operation circuit 10R calculates a video signal value Zout as a corrected value through only addition, subtraction, and multiplication, and outputs the calculated video signal value Zout.

Similarly, the correction operation circuit 10G also calculates the video signal value Zout as a corrected value by using the video signal value Zin as the G signal, the values read out from the G LUT unit 11G, and the values read out from the register 12G, and outputs the calculated video signal value Zout.

Similarly, the correction operation circuit 10B also calculates the video signal value Zout as a corrected value by using the video signal value Zin as the B signal, the values read out from the B LUT unit 11B, and the values read out from the register 12B, and outputs the calculated video signal value Zout.

The operation of the unevenness corrector 3 will be described below.

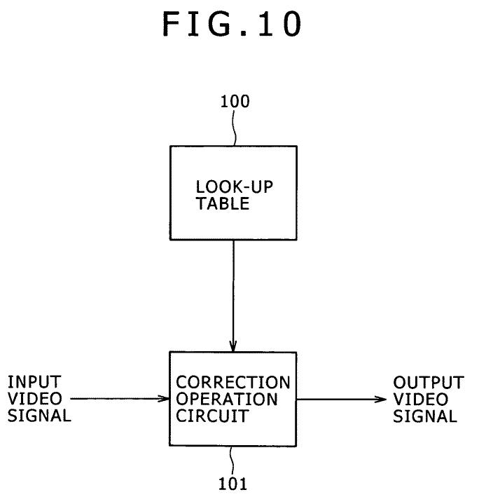

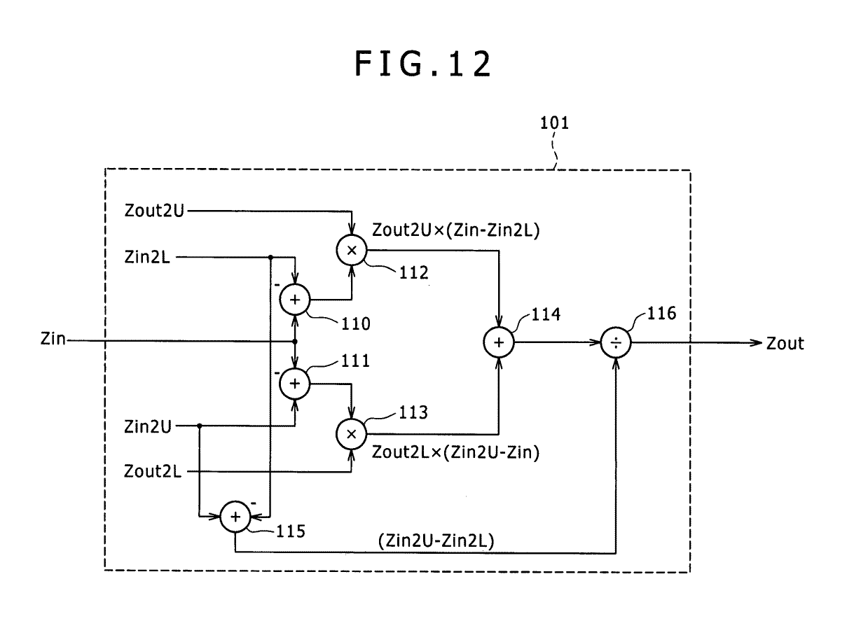

The following (Equation 2) is obtained by expanding (Equation 1), which is shown above as the equation representing the arithmetic operation executed by the related-art correction operation circuit 101 shown in FIGS. 10 and 12.

Zout={Zout2U/(Zin2U−Zin2L)}×(Zin−Zin2L)+{Zout2L/(Zin2U−Zin2L)}×(Zin2U−Zin) (Equation 2)

The respective terms of this (Equation 2) are as follows.

Zout denotes the corrected video signal value, and corresponds to the output value of the correction operation circuit 10 (10R, 10G, 10B) in the present example.

Zin denotes the video signal value input to the correction operation circuit 10 (10R, 10G, 10B).

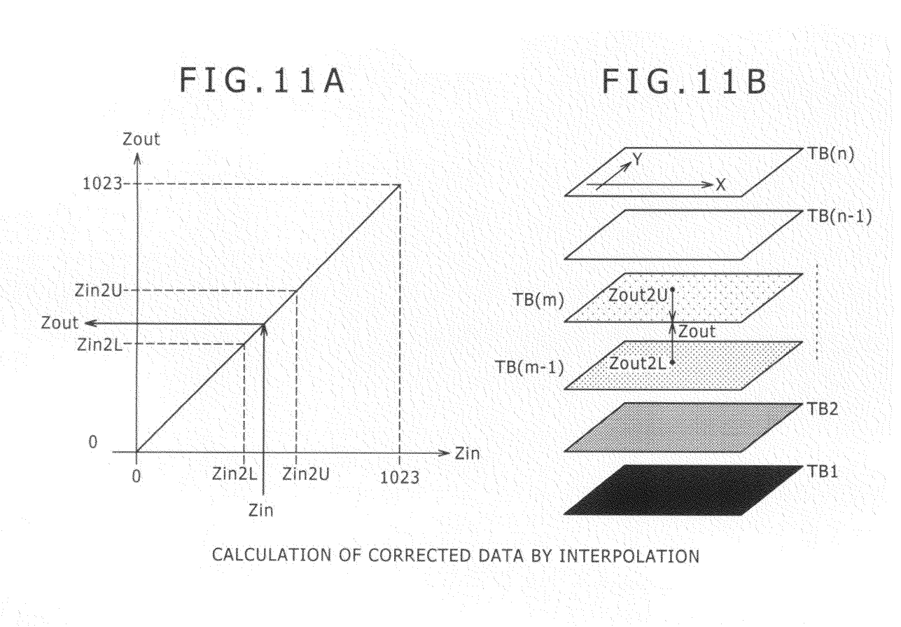

Zin2U and Zin2L denote the representative input values of two look-up tables TB(m) and TB(m−1) selected depending on the input video signal value Zin. As described above with FIG. 11, in response to the input video signal value Zin, two look-up tables TB(m) and TB(m−1) whose representative input values are larger and smaller, respectively, than this video signal value Zin and closest to this video signal value Zin are selected for linear interpolation.

The representative input value of the look-up table TB(m), larger than the input video signal value Zin, is defined as Zin2U, and the representative input value of the look-up table TB(m−1), smaller than the input video signal value Zin, is defined as Zin2L.

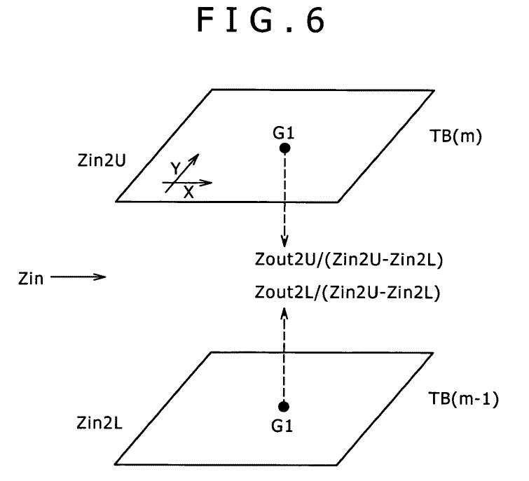

FIG. 6 schematically shows two look-up tables TB(m) and TB(m−1) selected depending on the input video signal value Zin. For example, if the look-up tables TB0 to TB16 are formed with the representative input values shown in FIG. 5A, when the input video signal value Zin is 500, the look-up table TB8 is used as the look-up table TB(m) and the look-up table TB7 is used as the look-up table TB(m−1).

Zout2U/(Zin2U−Zin2L) denotes the value for correction operation stored in the look-up table TB(m), whose representative input value is Zin2U.

Zout2L/(Zin2U−Zin2L) denotes the value for correction operation stored in the look-up table TB(m−1), whose representative input value is Zin2L.

That is, these values are operation result values as the results of division operation, read out from two look-up tables TB(m) and TB(m−1) dependent upon the input video signal value Zin.

Because the values of the respective terms of the operation result values Zout2U/(Zin2U−Zin2L) and Zout2L/(Zin2U−Zin2L) are known in advance, these operation result values can be calculated and stored in the look-up tables TB0 to TB16 in advance.

Specifically, (Zin2U−Zin2L) is the difference between the representative input values of two look-up tables TB(m) and TB(m−1), adjacent to each other.

For example, if the look-up tables TB(m) and TB(m−1) are the look-up tables TB2 and TB1, respectively, (Zin2U−Zin2L) as the difference between the representative input values of FIG. 5A is (128−64).

Zout2U and Zout2L are the corrected values corresponding to Zin2U and Zin2L, respectively, and are stored in look-up tables in the related-art system.

Therefore, the operation result values Zout2U/(Zin2U−Zin2L) and Zout2L/(Zin2U−Zin2L) can be calculated in advance. Thus, these values do not need to be calculated in real time by hardware but can be stored in the look-up tables TB0 to TB16.

Storing such operation result values in the look-up tables TB0 to TB16 allows the correction operation circuit 10 (10R, 10G, 10B) to calculate the output video signal value Zout resulting from the correction based on the configuration of FIG. 3.

The subtractor 21 subtracts, from the input video signal value Zin, the representative input value Zin2L of one look-up table TB(m−1) selected depending on the input video signal value Zin (Zin−Zin2L).

The representative input value Zin2L is read out from the register 12 (12R, 12G, 12B) and supplied to the subtractor 21.

The multiplier 23 multiplies the output of the subtractor 21 by the operation result value Zout2U/(Zin2U−Zin2L) read out from the look-up table TB(m) {Zout2U/(Zin2U−Zin2L)}×(Zin−Zin2L).

If, as shown in FIG. 6, the input video signal value Zin is the signal value for a pixel G1 specified by X and Y coordinates of the look-up tables TB(m) and TB(m−1), the operation result value stored corresponding to the X and Y coordinate values of the pixel G1 in the look-up table TB(m) is read out as Zout2U/(Zin2U−Zin2L) and supplied to the multiplier 23.

The subtractor 22 subtracts the input video signal value Zin from the representative input value Zin2U of the other look-up table TB(m) selected depending on the input video signal value Zin (Zin2U−Zin).

The representative input value Zin2U is read out from the register 12 (12R, 12G, 12B) and supplied to the subtractor 22.

The multiplier 24 multiplies the output of the subtractor 22 by the operation result value Zout2L/(Zin2U−Zin2L) read out from the look-up table TB(m−1) {Zout2L/(Zin2U−Zin2L)}×(Zin2U−Zin).

As shown in FIG. 6, the operation result value stored corresponding to the X and Y coordinate values of the pixel G1 in the look-up table TB(m−1) is read out as Zout2L/(Zin2U−Zin2L) and supplied to the multiplier 24.

The adder 25 adds the outputs of the multipliers 23 and 24 to each other. The output of the adder 25 is equivalent to the operation result of (Equation 2) and serves as the output video signal value Zout.

By the above-described operation, the output video signal value Zout resulting from the unevenness correction for the input video signal value Zin through linear interpolation can be achieved.

Also when the input video signal value Zin is the same as a certain representative input value, the output video signal value Zout is calculated through the same process by the circuit of FIG. 3.

For example, when the input video signal value Zin is equal to Zin2L, the output of the multiplier 23 is “0.”

Furthermore, (Zin2U−Zin2L) is equal to (Zin2U−Zin), and therefore the output of the multiplier 24 is Zout2L. Therefore, the output video signal value Zout from the adder 25 is equal to Zout2L. That is, the video signal value as the corrected value corresponding to Zin (=Zin2L) is obtained.

According to the present embodiment, the correction operation circuit 10 that executes linear interpolation operation about the grayscale direction of the 3D-γ can be achieved with a configuration that does not include a divider as hardware as described above.

This can eliminate the problems of increase in the system cost and difficulty in speed enhancement.

Moreover, using no divider eliminates the limit that the interval of the sampling of the representative input values along the Z axis (grayscale value) direction needs to be set to a power of two in order to simplify the divider.

The following three interval ways will be possible as the interval way of the grayscale division.
(1) equal intervals
(2) unequal intervals (the intervals are equal to powers of two)
(3) unequal intervals (the intervals are any intervals)

If no divider is used for the correction operation circuit 10 as with the present embodiment, any of these interval ways can be used.

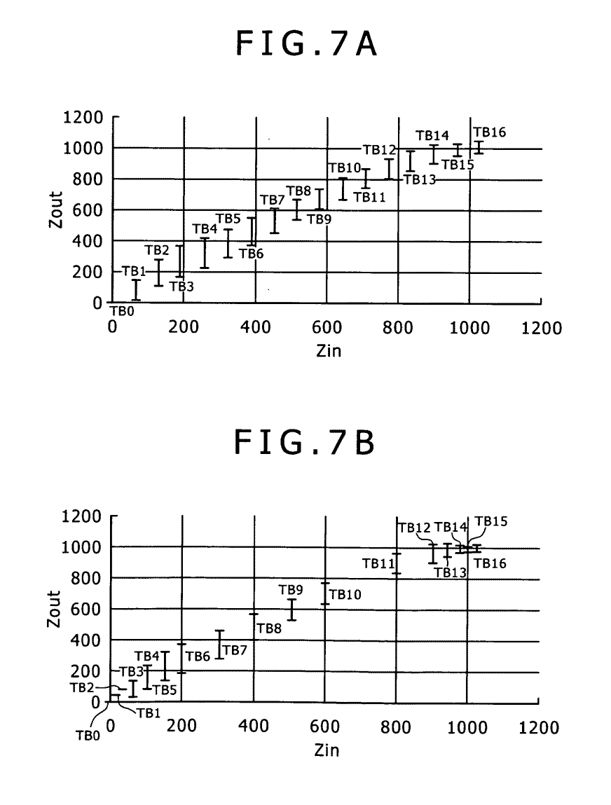

As described above, FIG. 5A shows the example in which grayscales are divided with equal intervals. In this case, as shown in FIG. 7A, which shows the relationship between the input video signal value Zin and the output video signal value Zout resulting from correction, the look-up tables TB0 to TB16 are set with the equal intervals.

The lines representing the respective look-up tables TB0 to TB16 in FIG. 7 each indicate the range of the numerical value as the output video signal value Zout resulting from the correction with respect to the representative input value of the look-up table, i.e. the range of variation in the corrected grayscale value when a video signal of uniform luminance is input to the entire screen.

On the other hand, FIG. 5B shows an example in which grayscales are divided with unequal intervals. FIG. 7B shows the look-up tables corresponding to the setting of the representative input values of FIG. 5B.

As shown in FIG. 7B, it is also easily possible to carry out flexible setting of the representative input values, such as unequal-interval sampling in which small intervals are set for a low-luminance range and a high-luminance range.

In this manner, any interval other than powers of two can be freely selected in the setting of the representative input values and substantially-equal intervals and unequal intervals can also be set. Furthermore, the intervals can be changed even after the circuit configuration as the correction operation unit is fixed. That is, the flexibility of the setting of the representative input values can be enhanced.

This is the end of the description of the embodiment of the present invention. It should be noted that the present invention is not limited to the above-described embodiment but various kinds of modification examples are possible besides the above-described examples.

What is claimed is:

1. A display device comprising:
a display unit configured to carry out video displaying on a display panel based on a supplied video signal; and
a video signal correcting unit configured to output a corrected video signal value obtained through arithmetic operation including division operation in response to an input video signal value, as correction processing suited to a characteristic of the display panel for a video signal to be supplied to the display unit, wherein
the video signal correcting unit includes
a memory table block having a plurality of reference tables that each correspond to a respective one of a plurality of representative input values as video signal values and each store operation result values of the division operation in advance, and
a correction operation block that calculates a corrected video signal value through arithmetic operation including all or a part of addition, subtraction, and multiplication by using an input video signal value and the operation result values read out from reference tables dependent upon the input video signal value in the memory table block.

2. The display device according to claim 1, wherein
arithmetic operation processing including the division operation is represented by an equation Zout={Zout2U/(Zin2U−Zin2L)}×(Zin−Zin2L)+{Zout2L/(Zin2U−Zin2L)}×(Zin2U−Zin), where,
Zout is a corrected video signal value,
Zin is a video signal value input to the correction operation block,
Zin2U and Zin2L are representative input values of two reference tables dependent upon the input video signal value,
Zout2U and Zout2L are corrected values corresponding to Zin2U and Zin2L, respectively, and
Zout2U/(Zin2U−Zin2L) and Zout2L/(Zin2U−Zin2L) are the operation result values read out from the two reference tables dependent upon the input video signal value.

3. The display device according to claim 2, wherein
the correction operation block includes:
a first subtractor that executes subtraction of (Zin−Zin2L);
a second subtractor that executes subtraction of (Zin2U−Zin);
a first multiplier that multiplies an output (Zin−Zin2L) from the first subtractor by the operation result value {Zout2U/(Zin2U−Zin2L)};
a second multiplier that multiplies an output (Zin2U−Zin) from the second subtractor by the operation result value {Zout2L/(Zin2U−Zin2L)}; and
an adder that adds outputs of the first multiplier and the second multiplier to each other.

4. The display device according to claim 1, wherein
the representative input values are set in such a way that a range from a minimum value to a maximum value as video signal values is divided with substantially-equal intervals, and the reference tables each corresponding to a respective one of the representative input values set with the substantially-equal intervals are prepared in the memory table block.

5. The display device according to claim 1, wherein
the representative input values are set in such a way that a range from a minimum value to a maximum value as video signal values is divided with unequal intervals, and the reference tables each corresponding to a respective one of the representative input values set with the unequal intervals are prepared in the memory table block.

6. A video signal correction device that outputs a corrected video signal value obtained through arithmetic operation including division operation in response to an input video signal value, as correction processing suited to a characteristic of a display panel for a video signal to be supplied to a display unit that carries out video displaying on the display panel based on a supplied video signal, the video signal correction device comprising:
a memory table block configured to have
a plurality of reference tables that each correspond to a respective one of a plurality of representative input values as video signal values and each store operation result values of the division operation in advance; and
a correction operation block configured to calculate a corrected video signal value through addition-and-subtraction operation and/or multiplication operation with use of an input video signal value and the operation result values read out from reference tables dependent upon the input video signal value in the memory table block.

7. A video signal correction method of outputting a corrected video signal value obtained through arithmetic operation including division operation in response to an input video signal value, as correction processing suited to a characteristic of a display panel for a video signal to be supplied to a display unit that carries out video displaying on the display panel based on a supplied video signal, the video signal correction method comprising the steps of:
referring to a memory table block having a plurality of reference tables that each correspond to a respective one of a plurality of representative input values as video signal values and each store operation result values of the division operation in advance, to thereby read out the operation result values from reference tables dependent upon an input video signal value; and
calculating a corrected video signal value through arithmetic operation including all or a part of addition, subtraction, and multiplication by using the input video signal value and the operation result values.

8. A display device comprising:
display means for carrying out video displaying on a display panel based on a supplied video signal; and
video signal correcting means for outputting a corrected video signal value obtained through arithmetic operation including division operation in response to an input video signal value, as correction processing suited to a characteristic of the display panel for a video signal to be supplied to the display means, wherein
the video signal correcting means includes
memory table means having a plurality of reference tables that each correspond to a respective one of a plurality of representative input values as video signal values and each store operation result values of the division operation in advance, and
correction operation means that calculates a corrected video signal value through arithmetic operation including all or a part of addition, subtraction, and multiplication by using an input video signal value and the operation result values read out from reference tables dependent upon the input video signal value in the memory table means.

9. A video signal correction device that outputs a corrected video signal value obtained through arithmetic operation including division operation in response to an input video signal value, as correction processing suited to a characteristic of a display panel for a video signal to be supplied to a display means that carries out video displaying on the display panel based on a supplied video signal, the video signal correction device comprising:
memory table means for having
a plurality of reference tables that each correspond to a respective one of a plurality of representative input values as video signal values and each store operation result values of the division operation in advance; and
correction operation means for calculating a corrected video signal value through addition-and-subtraction operation and/or multiplication operation with use of an input video signal value and the operation result values read out from reference tables dependent upon the input video signal value in the memory table means.
